(19) United States
(12) Patent Application Publication
(10) Pub. No.: US 2007/0295476 A1
(43) Pub. Date: Dec. 27, 2007

(54) Motor Vehicle Air-Conditioning System Provided With an Additional Heating

(75) Inventor: Karim Mathieu Bouchalat, Stuttgart (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/667,076

(22) PCT Filed: Oct. 12, 2006
(86) PCT No.: PCT/EP05/10977

§ 371 Date: Jul. 27, 2007

(30) Foreign Application Priority Data
Nov. 10, 2004 (DE) 10 2004 054 439.

(51) Int. Cl. B60H 1/03

(52) U.S. Cl. 165/42

(57) ABSTRACT

The invention relates to a motor vehicle air-conditioning system (1) provided with an additional heating in particular a fuel heating to be used as an auxiliary heating, wherein air can flow through a channel in two different opposite directions according to a shutter position. A method for operating the inventive air-conditioning system (1) is also disclosed.

The invention relates to a motor vehicle air-conditioning system provided with an additional heating according to the precharacterizing clause of claim 1.

A motor vehicle air-conditioning system is known with the arrangement in the main flow duct of an additional heating for an auxiliary heating mode, the additional heating being arranged downstream of the fan and upstream of the evaporator. An arrangement of this type still leaves something to be desired, in particular with regard to the pressure drop in the normal mode.

Starting from this prior art, it is the object of the invention to provide an improved motor vehicle air-conditioning system. This object is achieved by a motor vehicle air-conditioning system provided with an additional heating and with the features of claim 1. Advantageous refinements are the subject matter of the subclaims.

According to the invention, a motor vehicle air-conditioning system provided with an additional heating, in particular with a fuel heating, for an auxiliary heating mode, is provided, in which air can flow through an air duct in two different opposite directions as a function of positions of flaps. The optimum utilization of space thereby makes it possible to provide a compactly constructed air-conditioning system. Furthermore, the pressure drop in the normal mode is reduced on account of the optimized guidance of at least part of the air past the additional heating.

The air duct through which air can flow in two directions is preferably the cold air duct. This is preferably designed as a bypass to the heater.

In the auxiliary heating mode, the air duct preferably supplies air heated by the additional heating at least to one air duct continuing to the vehicle interior. In particular, this is preferably an air duct to the rear footwell, with it also being possible for said air duct to be arranged in a sleeping cab of a truck.

The additional heating is preferably a fuel heating. This is preferably arranged separated from the heater and evaporator of the air-conditioning system by an end wall, the end wall having at least one opening for the passage of an air duct to/from the additional heating.

A motor vehicle air-conditioning system of this type provided with an additional heating is, in particular, suitable for trucks.

The invention is explained in detail below using three exemplary embodiments and with reference to the drawing, in which:

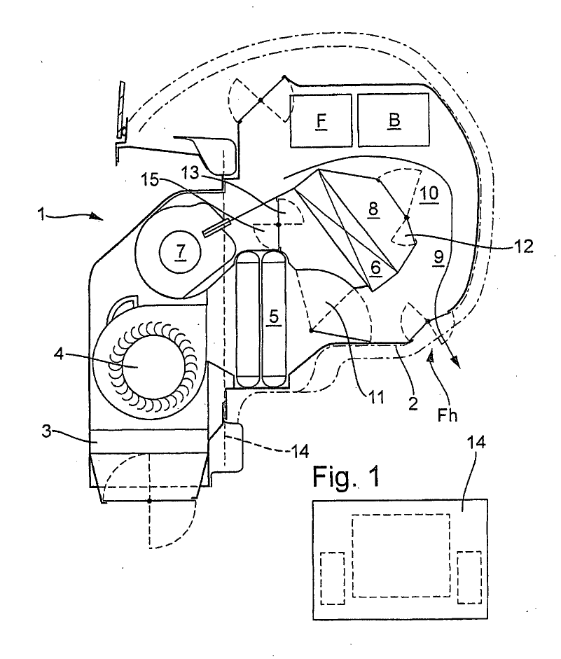

FIG. 1 shows a schematic illustration of a motor vehicle air-conditioning system according to the first exemplary embodiment, with the opening in the end wall being illustrated in the right-hand part,

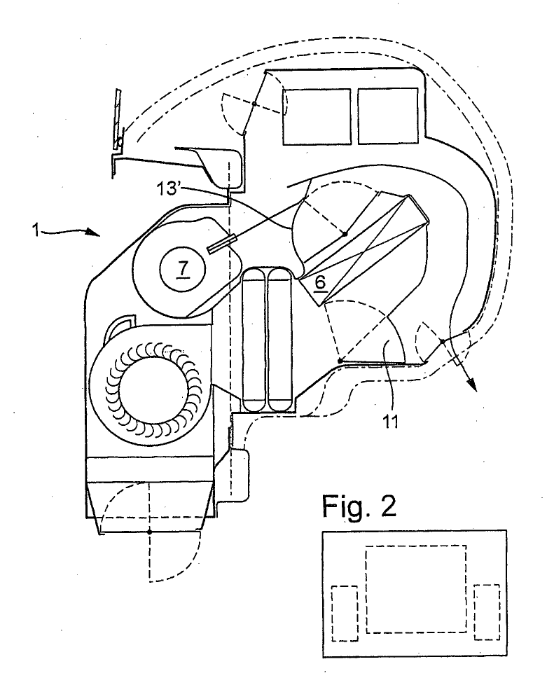

FIG. 2 shows a schematic illustration of a motor vehicle air-conditioning system according to the second exemplary embodiment, with the opening in the end wall being illustrated in the right-hand part,

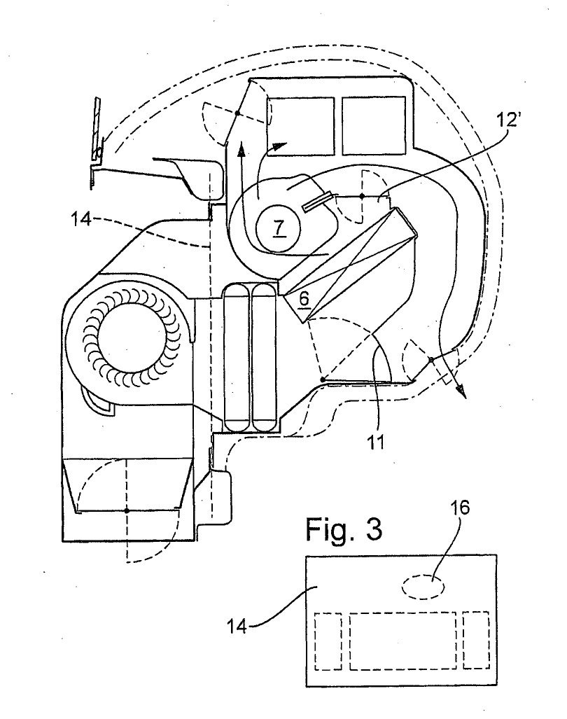

FIG. 3 shows a schematic illustration of a motor vehicle air-conditioning system according to the third exemplary embodiment, with the opening in the end wall being illustrated in the right-hand part, and

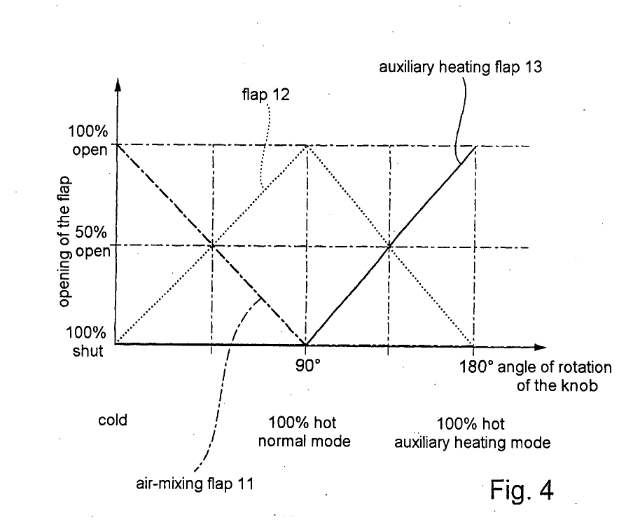

FIG. 4 shows a diagram for clarifying control of the flaps of the motor vehicle air-conditioning system according to the first exemplary embodiment.

A motor vehicle air-conditioning system 1 has a filter 3 arranged in a housing 2 and a fan 4 arranged downstream. Furthermore, an evaporator 5, a heater 6 and an additional or auxiliary heating 7 as the additional heating are arranged in the housing 2, with air which is to be-heated and is to be supplied to the vehicle interior flowing through the auxiliary heating 7, in particular in the auxiliary heating mode. Air to be heated can flow through said auxiliary heating in an additional heating mode too.

The function of the motor vehicle air-conditioning system 1 in the normal mode, i.e. with the engine running, does not differ from that of a conventional motor vehicle air-conditioning system. Thus, the air sucked up from the surroundings passes to the fan 4 through the filter 3, or the circulating air passes directly to the fan 4, from where the air flows through the evaporator 5. Depending on the desired temperature of the vehicle interior or type of operation, some or all of the cold air is directed through the heater 6 via a hot air duct 8 and/or is directed past said heater through a bypass or cold air duct 9. During a mixing mode, i.e. during a partial flow of air through the hot air duct 8, the cold and hot airflow is mixed in the mixing chamber 10 before the mixed, or possibly also stratified, air is supplied to the air ducts to the windshield (defrosting), to the footwell and/or to the interior ventilation. The temperature is controlled with the aid of an air-mixing flap 11, with a flap 12 which closes the hot air duct 8 when required being arranged at the end of the hot air duct 8. The auxiliary heating 7 is separated from the hot air duct 8 with the aid of an auxiliary heating flap 13 which is closed in the normal mode.

In the auxiliary heating mode, i.e. when the engine is at a standstill and the motor vehicle air-conditioning system 1 is essentially at a standstill, the air-mixing flap 11 closes the cold air duct 9. The hot air duct 8 is closed on the mixing-chamber side by the flap 12 whereas an air duct 15 is opened up through the auxiliary heating 7, by means of the auxiliary heating flap 13, such that the air sucked up by the electrically driven fan 4 flows through the auxiliary heating 7 and is heated by the same. The heated air can be supplied by the abovementioned air ducts directly to the windshield (defrosting) and to the vehicle interior. In addition, or—given an appropriate setting—the heated air passes exclusively directly into the rear footwell Fh or to the driver's sleeping cab (cf. arrow along the cold air duct 9 in FIG. 1). For this purpose, the air flows through the cold air duct 9 counter to the direction of flow of the normal mode. On account of the course of the flow, nonreturn flaps are not required either for the normal mode or for the auxiliary heating mode.

As is apparent from FIG. 1, the filter 3, the fan 4 and the auxiliary heating 7 are arranged to the left of the motor vehicle end wall 14, which is clarified by a dashed line, i.e. facing away from the vehicle interior. The other parts are arranged on the other side of the end wall 14, i.e. facing the vehicle interior, with the end wall 14 with the openings provided therein being illustrated schematically in the right-hand part of FIG. 1. The small openings, indicated by dashed lines, on the right and left of the central opening for the air ducts of the air-conditioning system 1 are for the circulating air which comes from the fan 4 and is to be supplied by the vehicle interior.

The three flaps 11, 12 and 13 can be controlled via a knob, which is rotatable through 180°, on the operating panel of the motor vehicle air-conditioning system, with the adjustment movement being transmitted via Bowden cables or an actuator (not illustrated). A curved disk is provided for the kinematics of the adjustment movements. The control of the flaps is illustrated in FIG. 4. It is apparent here that the air-mixing flap 11, starting from a maximum cooling power (0°), increasingly closes the cold air duct 9 during rotation of the knob and at higher desired temperatures associated therewith, while the flap 12 is correspondingly opened until the maximum heating power in the normal mode is reached, in the present case when the knob is rotated through 90° starting from the cold position. From this position with maximum heating power until the knob is rotated through 180° starting from the cold position, an additional or auxiliary heating mode takes place. For the additional heating mode, the flap 12 is closed in a stepwise manner and the auxiliary heating flap 13 is correspondingly opened, with the air-mixing flap 11 remaining in its position closing the cold air duct 9. In the maximum additional heating mode, the auxiliary heating flap 13 is completely opened and the flap 12 is completely closed. The auxiliary heating mode is involved when the engine is at a standstill. In the present case, at an angle of rotation of 135° and 180°, latching means are provided, with, at the latching means at the angle of 135°, additional heating while the engine is running taking place and, at the latching means at the angle of 180°, only heating using the auxiliary heating taking place. Other controls are possible, for example more steps between the angle of 90° and 180°, or just one step instead of the two steps described. Furthermore, it goes without saying that the range of rotation for the rotatable knob is not restricted to 180°; on the contrary, the steps described can also take place over a smaller or larger angular range.

According to the second exemplary embodiment illustrated in FIG. 2, the heater 6 is arranged in a rotated manner, with air which is to be heated flowing through the heater 6 even in the auxiliary heating mode. Owing to its arrangement behind the heater 6, the auxiliary heating flap 13′ also takes on the function of the flap 12, which is therefore omitted, and so, instead of three flaps, only two flaps are required according to the second exemplary embodiment. The heated air can again pass in the auxiliary heating mode directly into the rear footwell Fh or to the driver's sleeping cab, for which purpose air flows through the cold air duct 9 counter to the direction of flow in the normal mode. Furthermore, by air flowing through the heater 6 even in the auxiliary heating mode, use can be made of the residual heat of the heater 6 (i.e. the residual heat of the engine) irrespective of whether the auxiliary heating is fully or only partially switched on.

The third exemplary embodiment, which is illustrated in FIG. 3, essentially corresponds to the previously described second exemplary embodiment, but the auxiliary heating 7 is arranged on the other side of the end wall 14, for which reason an additional opening 16, illustrated schematically in the right-hand part of FIG. 3, for the connecting lines of the auxiliary heating 7 is also provided in the end wall 14, but the other openings can be made smaller. Furthermore, a special auxiliary heating flap 13 is not provided but rather just a flap 12′ which corresponds to the flap 12 and, in the auxiliary heating mode, defines the path of flow of air through the auxiliary heating 7. In the normal mode, some of the air can also flow through the auxiliary heating 7 (not heated). In this case too, in the auxiliary heating mode, the heated air can pass directly into the rear footwell Fh or to the driver's sleeping cab, for which purpose again the air flows through the cold air duct 9 counter to the direction of flow in the normal mode. This configuration permits an even more compact construction, since the auxiliary heating 7 is arranged directly above the heater 6 in the interior. As a result, the air also flows through it better than in the previously described exemplary embodiments.

### List of Designations

1 motor vehicle air-conditioning system
2 housing
3 filter
4 fan
5 evaporator
6 heater
7 auxiliary heating
8 hot air duct
9 cold air duct
10 mixing chamber
11 air-mixing flap
12, 12′ flap
13, 13′ auxiliary heating flap
14 end wall
15 air duct
16 opening
B interior ventilation
D defrosting
F footwell
Fh footwell at the rear
B interior ventilation

1. A motor vehicle air-conditioning system provided with an additional heating, in particular with a fuel heating, for an auxiliary heating mode, wherein air can flow through an air duct in two different opposite directions as a function of positions of flaps.

2. The motor vehicle air-conditioning system as claimed in claim 1, wherein the air duct is the cold air duct.

3. The motor vehicle air-conditioning system as claimed in claim 1, wherein, in the auxiliary heating mode, the air duct supplies air heated by the additional heating at least to one air duct continuing to the vehicle interior.

4. The motor vehicle air-conditioning system as claimed in claim 3, wherein the continuing air duct leads to the rear footwell.

5. The motor vehicle air-conditioning system as claimed in claim 1, wherein the additional heating is a fuel heating which is arranged separated from the heater and evaporator of the air-conditioning system by an end wall, the end wall having at least one opening for the passage of an air duct.

6. The motor vehicle air-conditioning system as claimed in claim 1, wherein an auxiliary heating flap which controls the airflow through the auxiliary heating is provided.

7. The motor vehicle air-conditioning system as claimed in claim 1, wherein an air-mixing flap which controls the hot airflow and the cold airflow is provided.

8. The motor vehicle air-conditioning system as claimed in claim 1, wherein a flap is provided, as seen in the normal direction of flow, at the end of the hot air duct and prevents hot air from flowing back through the heater in the auxiliary heating mode.

9. The motor vehicle air-conditioning system as claimed in claim 1, wherein air flows through the evaporator both in the normal mode and in the auxiliary heating mode.

10. A method for operating a motor vehicle air-conditioning system with a fan, an evaporator, a heater and an auxiliary heating, wherein, when the type of operation changes on account of a changed flap position, the direction of flow in at least one air duct is reversed.
